(19) United States
(12) Patent Application Publication
(10) Pub. No.: US 2010/0040843 A1
(43) Pub. Date: Feb. 18, 2010

(54) SHELL FOR PORTABLE ELECTRONIC DEVICE

(75) Inventor: CHUAN-WEI LIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/475,673

(22) Filed: Jun. 1, 2009

(30) Foreign Application Priority Data
Aug. 13, 2008 (CN) 200810303744.5

(51) Int. Cl. B32B 3/02

(52) U.S. Cl. 428/203

(57) ABSTRACT

A shell for a portable electronic device is provided including a transparent base shell, a pattern layer and a light-transmittable layer. The pattern layer includes a fully light-transmittable and colored pattern section and an anti-light-transmittable base section. The light-transmittable layer is not fully pervious to light and configured for hiding the pattern layer from view when the pattern layer is not being lit.

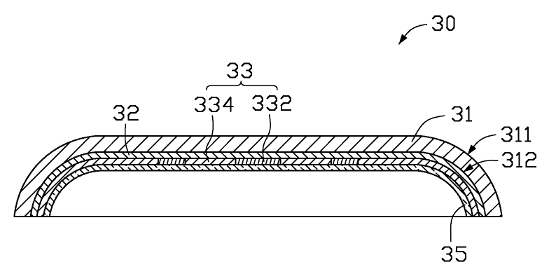

### BACKGROUND

1. Technical Field

The present disclosure relates to a shell for portable electronic devices.

2. Description of Related Art

Nowadays, shells for portable electronic devices are usually decorated with patterns e.g., to improve the aesthetic appearance. Typically, the patterns are directly printed/coated at the exterior surface of the shells. However, once printed/coated, the patterns cannot be changed/altered. Some consumers might find those patterns boring after a period of time.

Therefore, there is room for improvement within the art.

### BRIEF DESCRIPTION OF THE DRAWING

Many aspects of the new shell for portable electronic devices can be better understood with reference to the drawing. The components in the drawings are not necessarily drawn to scale, the emphasis instead being placed upon clearly illustrating the principles of the new shell for portable electronic devices.

The drawing is a cross sectional view of a shell according to an exemplary embodiment.

### DETAILED DESCRIPTION

Referring to the drawing, the exemplary shell 30 for portable electronic devices (e.g., mobile phones) includes a transparent base shell 31, a light-transmittable layer 32, a pattern layer 33, and a transparent protective layer 35.

The base shell 31 can be made of one or more material selected from the group consisting of Poly Carbonate (PC) and Polymethyl Methacrylate (PMMA). The base shell 31 includes an exterior surface 311 and an interior surface 312.

The light-transmittable layer 32 is directly formed on the interior surface 312 of the base shell 31. The light-transmittable layer 32 is not fully pervious to light and can be an ink layer, a coating layer or a vacuum deposited layer.

The pattern layer 33 is directly formed on the light-transmittable layer 32, such that the light-transmittable layer 32 is arranged between the pattern layer 33 and the base shell 31. The pattern layer 33 includes a pattern section 332 and a base section 334. The pattern section 332 is comprised of a light-transmittable ink with a predetermined color. The base section 334 is comprised of an anti-light-transmittable ink.

The protective layer 35 covers the pattern layer 33 to protect the pattern layer 33 e.g., from being erased or eroded. The protective layer 35 can be transparent ink. It is to be understood that the protective layer 35 can be removed from the shell 30.

The portable electronic device assembled with the shell 30 also includes a plurality of light sources (not shown) below the pattern section 332 of the shell 30. When the light sources are not illuminating, the pattern section 332 is not visible and is hidden by the light transmittable layer 32 At this time, the shell 30 appears with the color of the light-transmittable layer 32. In other words, users can only see the light-transmittable layer 32 below the protective layer 35. When the lighting sources illuminates, the light therefrom penetrates through the transparent protective layer 35, the pattern section 332 and the light-transmittable layer 32 in the written order to the outside. At this stage, the shell 30 appears with the color of the pattern section 332 and the color of the light-transmittable layer 32. In other words, users can see the light-transmittable layer 32 mixed with the pattern section 332 below the protective layer 35. Thus, the portable electronic device will have a first appearance when the internal light sources are not illuminating and a second appearance with the internal light sources are illuminating.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shell for a portable electronic device, comprising:
a transparent base shell comprising an exterior surface and an interior surface opposite to the exterior surface;
a light-transmittable layer directly formed on the interior surface, the light-transmittable layer being not fully pervious to light; and
a pattern layer directly formed on the light-transmittable layer, the light-transmittable layer located between the base shell and the pattern layer, the pattern layer comprising a pattern section and a base section, the pattern section being light-transmittable by a predetermined color and the base section being anti-light-transmittable.

2. The shell as claimed in claim 1, wherein the light-transmittable layer is selected from group consisting of an ink layer, a coating layer and a vacuum deposited layer.

3. The shell as claimed in claim 1, wherein the pattern section is comprised of a light-transmittable ink with a predetermined color.

4. The shell as claimed in claim 3, wherein the base section is comprised of an anti-light-transmittable ink.

5. The shell as claimed in claim 1, further comprising a transparent protective layer covering the pattern layer.

6. The shell as claimed in claim 5, wherein the transparent protective layer is consisted of transparent ink.

7. A shell for a portable electronic device, comprising:
a transparent base shell;
a pattern layer comprising a fully light-transmittable and colored pattern section and an anti-light-transmittable base section; and
a light-transmittable layer being not fully pervious to light and configured for hiding the pattern layer from view when the pattern layer is not being lit.

8. The shell as claimed in claim 7, wherein:
the transparent base shell comprises an exterior surface and an interior surface opposite to the exterior surface;
the light-transmittable layer is directly formed on the interior surface; and
the pattern layer is directly formed on the light-transmittable layer, the light-transmittable layer located between the base shell and the pattern layer.

9. The shell as claimed in claim 8, wherein the light-transmittable layer is selected from group consisting of an ink layer, a coating layer and a vacuum deposited layer.

10. The shell as claimed in claim 8, wherein the pattern section is comprised of a light-transmittable ink with a predetermined color.

11. The shell as claimed in claim 10, wherein the base section is comprised of an anti-light-transmittable ink.

12. The shell as claimed in claim 8, further comprising a transparent protective layer covering the pattern layer.

13. The shell as claimed in claim 12, wherein the transparent protective layer is consisted of transparent ink.
